(19) United States
(12) Patent Application Publication
(10) Pub. No.: US 2019/0383900 A1
(43) Pub. Date: Dec. 19, 2019

(54) JOINT OPTIMIZATION OF ANTENNA SPACING AND TARGET ANGLE ESTIMATION IN A RADAR SYSTEM

(71) Applicant: GM Global Technology Operations LLC, Detroit, MI (US)

(72) Inventors: Oded Bialer, Petah Tivak (IL); Noa Garnett, Herzliya (IL); Dan Levi, Kyriat Ono (IL)

(21) Appl. No.: 16/010,698

(22) Filed: Jun. 18, 2018

(51) Int. Cl. G01S 7/40; H01Q 1/32; G01S 13/93; G01S 13/06; G01S 7/41

(52) U.S. Cl. CPC G01S 7/4021; H01Q 1/3233; G01S 13/931; H01Q 21/00; G01S 7/40; G01S 7/417; G01S 13/06

(57) ABSTRACT

A radar system and a method to configure the radar system involve one or more transmit antennas to transmit a radio frequency signal, and one or more receive antennas to receive reflected energy based on the radio frequency signal transmitted by the one or more transmit antennas. The one or more transmit antennas and the one or more receive antennas are arranged in an array. A processor jointly determines a spacing among the one or more transmit antennas and the one or more receive antennas arranged in the array and a mapping between data obtained by the one or more receive antennas and an angle of arrival of one or more targets detected in the data. Joint determination refers to both determination of the spacing being in consideration of the mapping and determination of the mapping being in consideration of the spacing.

### INTRODUCTION

The subject disclosure relates to joint optimization of antenna spacing and target angle estimation in a radar system.

Vehicles (e.g., automobiles, trucks, construction equipment, farm equipment, automated manufacturing equipment) increasingly use sensors to detect objects in their vicinity. The detection may be used to augment or automate vehicle operation. Exemplary sensors include cameras, light detection and ranging (lidar) systems, radio detection and ranging (radar) systems. A radar system may include multiple antennas. When multiple close-in targets appear at the same range and velocity from the radar system, resolving and accurately estimating their angles of arrival is a known challenge in radar applications. In conventional radar systems with multiple antennas, the spacing between antennas is determined such that a standard beamforming algorithm will provide a narrow main lobe (i.e., maximum amplitude response) at the target angle and low sidelobes or amplitudes at other angles. This approach is indirect, because it is based on an implicit relationship between the main lobe and sidelobes and the estimation of target angles. An analytical determination of the dependence of angle of arrival estimation on the spacing of antennas is difficult. Accordingly, it is desirable to provide joint optimization of antenna spacing and target angle estimation in a radar system.

### SUMMARY

In one exemplary embodiment, a radar system includes one or more transmit antennas to transmit a radio frequency signal, and one or more receive antennas to receive reflected energy based on the radio frequency signal transmitted by the one or more transmit antennas. The one or more transmit antennas and the one or more receive antennas are arranged in an array. The radar system also includes a processor to jointly determine a spacing among the one or more transmit antennas and the one or more receive antennas arranged in the array and a mapping between data obtained by the one or more receive antennas and an angle of arrival of one or more targets detected in the data. Joint determination refers to both determination of the spacing being in consideration of the mapping and determination of the mapping being in consideration of the spacing.

In addition to one or more of the features described herein, the mapping between data obtained by the one or more receive antennas and the angle of arrival of one or more targets detected in the data is performed with a neural network.

In addition to one or more of the features described herein, the neural network is trained according to an iterative process using, as input, the data obtained by the one or more receive antennas for a set of scenarios involving a specified number of targets at specified positions.

In addition to one or more of the features described herein, the neural network is trained using, as feedback, a difference between estimated angles of arrival according to the mapping and actual angles of arrival according to target positions resulting in the data.

In addition to one or more of the features described herein, the target positions are simulated.

In addition to one or more of the features described herein, the radar system also includes an alternating switch to implement the iterative process of training the neural network and the process of determining the spacing in turn.

In addition to one or more of the features described herein, the mapping is determined for an initial spacing and the spacing is then determined based on the mapping.

In addition to one or more of the features described herein, the spacing is determined for an initial mapping and the mapping is then determined based on the spacing.

In addition to one or more of the features described herein, the radar system is disposed in a vehicle to provide information to augment or automate operation of the vehicle.

In another exemplary embodiment, a method of configuring a radar system includes arranging one or more transmit antennas and one or more receive antennas in an array, and jointly determining a spacing among the one or more transmit antennas and the one or more receive antennas arranged in the array and a mapping between data obtained by the one or more receive antennas and an angle of arrival of one or more targets detected in the data. The jointly determining refers to both determining the spacing in consideration of the mapping and determining the mapping in consideration of the spacing.

In addition to one or more of the features described herein, the method also includes performing the mapping between data obtained by the one or more receive antennas and the angle of arrival of one or more targets detected in the data with a neural network.

In addition to one or more of the features described herein, the method also includes training the neural network according to an iterative process using, as input, the data obtained by the one or more receive antennas for a set of scenarios involving a specified number of targets at specified positions.

In addition to one or more of the features described herein, the method also includes training the neural network using, as feedback, a difference between estimated angles of arrival according to the mapping and actual angles of arrival according to target positions resulting in the data.

In addition to one or more of the features described herein, the method also includes simulating the target positions.

In addition to one or more of the features described herein, the method also includes configuring an alternating switch to implement the iterative process of training the neural network and the process of determining the spacing in turn.

In addition to one or more of the features described herein, the jointly determining includes determining the mapping for an initial spacing and then determining the spacing based on the mapping.

In addition to one or more of the features described herein, the jointly determining includes determining the spacing for an initial mapping and then determining the mapping based on the spacing.

In yet another exemplary embodiment, a vehicle includes a radar system that includes one or more transmit antennas to transmit a radio frequency signal, and one or more receive antennas to receive reflected energy based on the radio frequency signal transmitted by the one or more transmit antennas. The one or more transmit antennas and the one or more receive antennas are arranged in an array. A processor determines a spacing among the one or more transmit antennas and the one or more receive antennas arranged in the array and a mapping between data obtained by the one or more receive antennas and an angle of arrival of one or more targets detected in the data. Joint determination refers to both determination of the spacing being in consideration of the mapping and determination of the mapping being in consideration of the spacing. The vehicle also includes a vehicle controller to use information from the radar system to augment or automate operation of the vehicle.

In addition to one or more of the features described herein, the mapping between data obtained by the one or more receive antennas and the angle of arrival of one or more targets detected in the data is performed with a neural network.

In addition to one or more of the features described herein, the mapping is determined for an initial spacing and the spacing is then determined based on the mapping, or the spacing is determined for an initial mapping and the mapping is then determined based on the spacing.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a scenario involving a radar system according to one or more embodiments;

FIG. 2 details aspects of an exemplary radar system that undergoes joint optimization of antenna spacing and target angle estimation according to one or more embodiments; and

FIG. 3 is a process flow of the method of performing joint optimization of antenna spacing and target angle estimation according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, a radar system with multiple antennas must distinguish the relative angles of multiple targets that appear at the same range. While target angle of arrival estimation is dependent on the antenna array configuration (i.e., spacing among antennas), this dependency is difficult to determine analytically. Embodiments of the systems and methods detailed herein relate to joint optimization of antenna spacing and target angle estimation in a radar system. A machine learning approach is applied iteratively to a number of angles of arrival to converge on an antenna spacing configuration and on parameters for angle of arrival estimation.

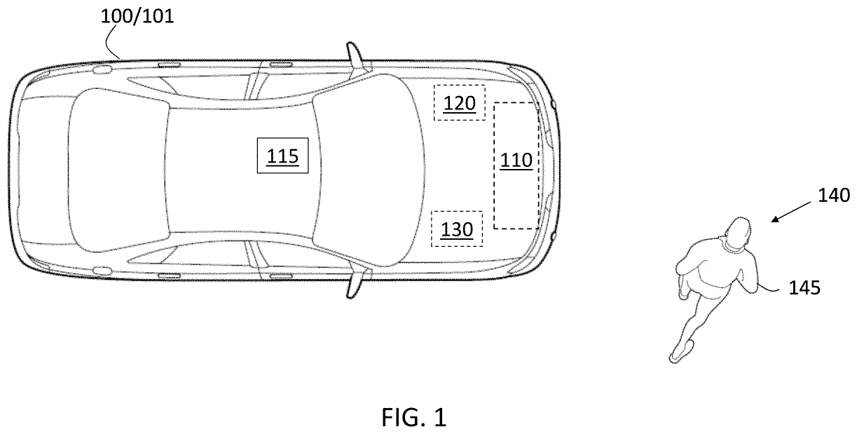

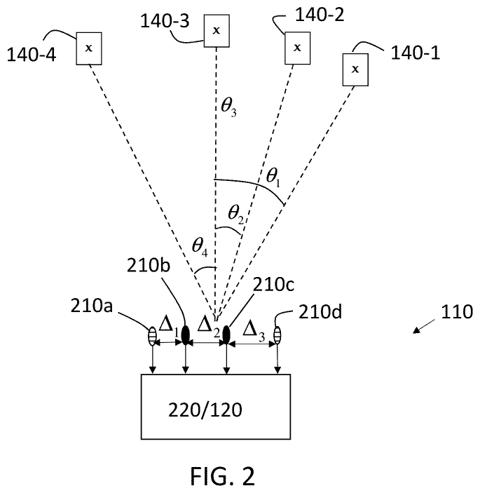

In accordance with an exemplary embodiment, FIG. 1 is a block diagram of a scenario involving a radar system 110. The vehicle 100 shown in FIG. 1 is an automobile 101. A radar system 110, further detailed with reference to FIG. 2, is shown under the hood of the automobile 101. According to alternate or additional embodiments, one or more radar systems 110 may be located elsewhere in or on the vehicle 100. Another sensor 115 (e.g., camera, sonar, lidar system) is shown, as well. Information obtained by the radar system 110 and one or more other sensors 115 may be provided to a controller 120 (e.g., electronic control unit (ECU)) for image or data processing, target recognition, and subsequent vehicle control.

The controller 120 may use the information to control one or more vehicle systems 130. In an exemplary embodiment, the vehicle 100 may be an autonomous vehicle and the controller 120 may perform known vehicle operational control using information from the radar system 110 and other sources. In alternate embodiments, the controller 120 may augment vehicle operation using information from the radar system 110 and other sources as part of a known system (e.g., collision avoidance system, adaptive cruise control system, driver alert). The radar system 110 and one or more other sensors 115 may be used to detect objects 140, such as the pedestrian 145 shown in FIG. 1. The controller 120 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

FIG. 2 details aspects of an exemplary radar system 110 that undergoes joint optimization of antenna spacing and target angle estimation according to one or more embodiments. The exemplary radar system 110 includes four antennas 210a, 210b, 210c, 210d (generally referred to as 210). According to one exemplary embodiment, the antennas 210a, 210d may be transmit antennas while the antennas 210b, 210c may be receive antennas. The number and arrangement of the antennas 210 is not limited by the exemplary embodiment shown in FIG. 2. Exemplary distances between antennas 210 are indicated in FIG. 2. The distance between antennas 210a and 210b is Δ₁, the distance between antennas 210b and 210c is Δ₂, and distance between antennas 210c and 210d is Δ₃.

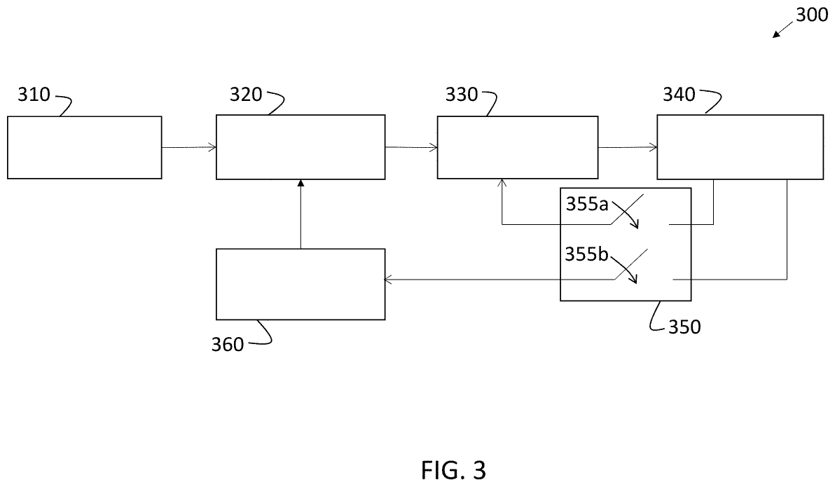

For explanatory purposes, four targets 140-1, 140-2, 140-3, 140-4 (generally referred to as 140) are shown at approximately the same range to the radar system 110. The angles of arrival of each of the targets 140 from a center of the array of antennas 210 is indicated. The angle to target 140-1 is indicated as θ₁, the angle to target 140-2 is indicated as θ₂, the angle to target 140-3 is indicated as θ₃ (which is 0 degrees in the example), and the angle to target 140-4 is indicated as θ₄. Signals transmitted or received by the antennas 210 are processed by a processor 220 of the radar system 110 or by the controller 120 according to alternate embodiments. The joint optimization process detailed with reference to FIG. 3 may also be performed using the processor 220, controller 120, or a combination of the two. The processor 220, like the controller 120, may include processing circuitry that may include an application specific integrated circuit (ASIC), an electronic circuit, a processor (shared, dedicated, or group) and memory that executes one or more software or firmware programs, a combinational logic circuit, and/or other suitable components.

FIG. 3 is a process flow of a method 300 of performing joint optimization of antenna spacing and target angle estimation according to one or more embodiments. At block 310, generating target positions includes simulating targets 140 at different angles offline, according to an exemplary embodiment, or performing online (i.e., live) testing with targets 140 positioned at different angles in alternate embodiments. The process of generating target positions, at block 310, is performed iteratively (e.g., up to thousands of times), as further discussed. At block 360, configuring antenna positions begins with an initial configuration of positions for the antennas 210 (i.e., initial distances among the antennas 210).

For a set of target positions (provided by block 310) and a configuration of antenna positions (set at block 360), obtaining antenna outputs, at block 320 may refer to simulating radar receiver outputs or obtaining outputs from receive antennas 210. At block 330, estimating angles of arrival from the antenna outputs (obtained at block 320) involves a machine learning process according to exemplary embodiments. Machine learning and, in particular, the implementation of machine learning through a neural network, is well known and only generally described here. Neural networks involve the use of training data to learn a function. Generally, the function may be described as classification. In the current application, the antenna outputs (obtained at block 320) are classified into a specified number of targets and their angles of arrival. The classification may be regarded as a mapping, and the estimation error determined at block 340 is used to improve the mapping over the iterations, as discussed further.

At block 340, determining estimation error refers to comparing the angles of arrival estimated at block 330 with the angles of arrival according to the target positions generated at block 310. That is, the estimates according to the neural network are compared with ground truth. The estimation error determined at block 340 may be used in the joint optimization of antenna spacing and target angle estimation according to different embodiments that are based on different operations of the alternating switch 350, which alternately closes switches 355a or 355b (generally referred to as 355). That is, alternating switch 350 ensures that only one of the switches 355 is closed at a given time.

According to one exemplary embodiment, target angle estimation, which is performed at block 330, is optimized before antenna spacing, which is configured at block 360, is optimized. Thus, according to the exemplary embodiment, the switch 355a is closed and the switch 355b is open initially. The configuration of antenna positions that is set at block 360 is maintained over iterations of generating target positions, at block 310, obtaining antenna outputs, at block 320, estimating angles of arrival, at block 330, determining estimation error, at block 340, and looping between blocks 330 and 340 to determine parameters of the neural network that minimize the estimation error for each iteration. Parameters of the neural network may be modified to improve the estimate of angles of arrival (at block 330) by using the estimation error (determined at block 340) as feedback. That is, parameters of the neural network may be modified to minimize an estimation error metric such as, for example, squared error of the difference between each true angle of arrival (according to the generated target positions at block 310) and the closest estimated angle of arrival among multiple targets (estimated at block 330).

Once the neural network parameters are optimized according to this inner loop (i.e., the loop with switch 355a closed) being processed over many iterations, then the switch 355a is opened and the switch 355b is closed by the alternating switch 350. With the optimized neural network parameters being maintained, at block 330, the configuration of antenna positions is then changed, at block 360, as part of the outer loop until the estimation error, which is determined at block 340, no longer decreases based on modifying the antenna positions, at block 360. That is estimation error (determined at block 340) may be used as feedback to optimize the configuration of the antenna positions (at block 360) iteratively. A metric relating to estimation error (determined at block 340) may be used as feedback to reconfigure the antenna positions (at block 360). An exemplary metric is, for example, squared error of the difference between each true angle of arrival (according to the generated target positions at block 310) and the closest estimated angle of arrival among multiple targets (estimated at block 330).

According to an alternate exemplary embodiment, the joint optimization of antenna spacing and target angle estimation is performed in the opposite order. That is, antenna spacing is optimized (according to the outer loop, based on the switch 355b being closed) first before target angle estimation is optimized (according to the inner loop, based on the switch 355a being closed). With switch 355a open and switch 355b closed, target positions are iteratively generated, at block 310. For each iteration, the processes at blocks 320, 330, 340, and 360 are performed. Specifically, the estimation error determined at block 340 is used to modify antenna spacing, at block 360. The loop of processes at blocks 310, 320, 330, 340, and 360 may be repeated (i.e., the outer loop) for thousands of iterations until estimation error is minimized. After the outer loop optimization of antenna positions (i.e., spacing) is completed, then switch 355a is closed and switch 355b is opened to use the inner loop, as previously described, to optimize the neural network parameters that minimize estimation error.

According to further alternate embodiments, a combination of inner and outer-loop optimization may be performed. The exemplary orders discussed herein for explanatory purposed are not intended to limit the various ways that angle of arrival estimation and antenna position may be jointly optimized. When the processes shown in FIG. 3 are completed, the antennas 210 of the radar system 110 are arranged according to the spacing determined at block 360, and angles of arrival are estimated during subsequent operation of the radar system 110 according to the neural network trained at block 330. The joint optimization means that the antenna spacing determined at block 360 and the angle of arrival estimation determined at block 330 are complementary. That is, the antenna spacing determined at block 360 is the optimal antenna spacing for the angle of arrival estimation mapping determined at block 330 and the angle of arrival estimation mapping determined at block 330 is the optimal angle of arrival estimation mapping for the antenna spacing determined at block 360.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A radar system, comprising:
one or more transmit antennas to transmit a radio frequency signal;
one or more receive antennas to receive reflected energy based on the radio frequency signal transmitted by the one or more transmit antennas, wherein the one or more transmit antennas and the one or more receive antennas are arranged in an array;
a processor configured to jointly determine a spacing among the one or more transmit antennas and the one or more receive antennas arranged in the array and a mapping between data obtained by the one or more receive antennas and an angle of arrival of one or more targets detected in the data, wherein joint determination refers to both determination of the spacing being in consideration of the mapping and determination of the mapping being in consideration of the spacing.

2. The radar system according to claim 1, wherein the mapping between data obtained by the one or more receive antennas and the angle of arrival of one or more targets detected in the data is performed with a neural network.

3. The radar system according to claim 2, wherein the neural network is trained according to an iterative process using, as input, the data obtained by the one or more receive antennas for a set of scenarios involving a specified number of targets at specified positions.

4. The radar system according to claim 3, wherein the neural network is trained using, as feedback, a difference between estimated angles of arrival according to the mapping and actual angles of arrival according to target positions resulting in the data.

5. The radar system according to claim 4, wherein the target positions are simulated.

6. The radar system according to claim 3, further comprising an alternating switch to implement the iterative process of training the neural network and the process of determining the spacing in turn.

7. The radar system according to claim 1, wherein the mapping is determined for an initial spacing and the spacing is then determined based on the mapping.

8. The radar system according to claim 1, wherein the spacing is determined for an initial mapping and the mapping is then determined based on the spacing.

9. The radar system according to claim 1, wherein the radar system is disposed in a vehicle to provide information to augment or automate operation of the vehicle.

10. A method of configuring a radar system, the method comprising:
arranging one or more transmit antennas and one or more receive antennas in an array;
jointly determining a spacing among the one or more transmit antennas and the one or more receive antennas arranged in the array and a mapping between data obtained by the one or more receive antennas and an angle of arrival of one or more targets detected in the data, wherein the jointly determining refers to both determining the spacing in consideration of the mapping and determining the mapping in consideration of the spacing.

11. The method according to claim 10, further comprising performing the mapping between data obtained by the one or more receive antennas and the angle of arrival of one or more targets detected in the data with a neural network.

12. The method according to claim 11, further comprising training the neural network according to an iterative process using, as input, the data obtained by the one or more receive antennas for a set of scenarios involving a specified number of targets at specified positions.

13. The method according to claim 12, further comprising training the neural network using, as feedback, a difference between estimated angles of arrival according to the mapping and actual angles of arrival according to target positions resulting in the data.

14. The method according to claim 13, further comprising simulating the target positions.

15. The method according to claim 12, further comprising configuring an alternating switch to implement the iterative process of training the neural network and the process of determining the spacing in turn.

16. The method according to claim 10, wherein the jointly determining includes determining the mapping for an initial spacing and then determining the spacing based on the mapping.

17. The method according to claim 10, wherein the jointly determining includes determining the spacing for an initial mapping and then determining the mapping based on the spacing.

18. A vehicle, comprising:
a radar system comprising:
one or more transmit antennas to transmit a radio frequency signal;
one or more receive antennas to receive reflected energy based on the radio frequency signal transmitted by the one or more transmit antennas, wherein the one or more transmit antennas and the one or more receive antennas are arranged in an array;
a processor configured to jointly determine a spacing among the one or more transmit antennas and the one or more receive antennas arranged in the array and a mapping between data obtained by the one or more receive antennas and an angle of arrival of one or more targets detected in the data, wherein joint determination refers to both determination of the spacing being in consideration of the mapping and determination of the mapping being in consideration of the spacing; and
a vehicle controller configured to use information from the radar system to augment or automate operation of the vehicle.

19. The vehicle according to claim 18, wherein the mapping between data obtained by the one or more receive antennas and the angle of arrival of one or more targets detected in the data is performed with a neural network.

20. The vehicle according to claim 18, wherein the mapping is determined for an initial spacing and the spacing is then determined based on the mapping, or the spacing is determined for an initial mapping and the mapping is then determined based on the spacing.
